(19) United States
(12) Patent Application Publication
(10) Pub. No.: US 2008/0179334 A1
(43) Pub. Date: Jul. 31, 2008

(54) CONTAINER FOR HOLDING AND MIXING A BEVERAGE

(75) Inventors: Nelson Abramson, San Francisco, CA (US); Diana Chen, San Francisco, CA (US); Jordan Roy Nelson, Pennington, NJ (US)

Correspondence Address: DARBY & DARBY P.C., P.O. BOX 770, Church Street Station, New York, NY, 10008-0770, US

(73) Assignee: Innovative Design Group, San Francisco, CA (US)

(21) Appl. No.: 12/022,476

(22) Filed: Jan. 30, 2008

Related U.S. Application Data
(60) Provisional application No. 60/887,272, filed on Jan. 30, 2007.

(51) Int. Cl. B01F 11/00; B01F 13/00; B65D 6/00

(52) U.S. Cl. 220/568; 366/348; 220/4.01

(57) ABSTRACT

A method of distributing and mixing a drink includes the steps of: providing a first container body and filling the first container body with a first fluid such that the first fluid is sealingly held within the first container body. The first container body has a first feature that permits the first fluid to selectively flow from the first container body. The method also includes the step of providing a second container body for holding a second fluid. The second container body has a second feature that permits the second fluid to flow from the second container body. The second container body is filled with the second fluid. The first and second container bodies are joined such that the first and second fluids are separated from one another and are sealingly contained within the first and second container bodies, respectively. In addition, at least one of the first and second container bodies is manipulated at a point of use to provide fluid communication therebetween resulting in mixing of the first and second fluids.

### CROSS REFERENCE TO RELATED APPLICATION

The present application claims the benefit of U.S. patent application Ser. No. 60/887,272, filed Jan. 30, 2007, which is hereby incorporated by reference in its entirety.

### TECHNICAL FIELD

The present invention relates generally to containers for holding a beverage, such as an alcoholic beverage, and more particularly, to a container that separately holds two ingredients of the beverage until a consumer manipulates the container to cause mixing of the beverage.

### BACKGROUND

There are an ever growing number of different types of alcoholic beverages, including beer, wine and spirits that are enjoyed by millions throughout the world. In addition, there is an increasing need and demand for pre-mixed or prepared alcoholic beverages that can easily be dispensed to consumers without the need for timely preparation of the beverage and there is also a need for a beverage that can be distributed in smaller volumes. This has led to a surge in the sheer quantity and variety of prepared alcoholic beverages that are marketed in single drink containers. For example, there are a number of wine based bottled drinks commonly known as “wine coolers” that come in a 12 ounce bottle and are available in a wide variety of flavors, such as mixed berry, pina colada, strawberry daiquiri, to name a few. These products are usually distributed in a four pack. In addition, small 187 ml bottles of wine are available in four packs and are perfect for occasions when you would like to enjoy a glass of wine but it's just not practical to bring a standard, larger size bottle along. All different types of wine, including Cabernet Sauvignon, Shiraz, Merlot, Chardonnay, etc. are available in this size. These easy-to-tote, portable bottles hold approximately a glass and a half of wine and thus are perfect for a number of different settings, including picnics.

These smaller, single drink beverages are not limited to wine since there are a number of different spirit based mixed bottled drinks that are available. Once again, these drinks typically come pre-mixed in a 187 ml glass bottle that can be enjoyed by the consumer. There is a popular line of flavored whiskey drinks, including whiskey blended with punch, lemonade, berry drinks, citrus and watermelon; and in addition, some other popular drinks including, Kahlua mudslide, margaritas, etc. However, most, if not all, of these drinks come in standard small sized glass bottles that are not that aesthetically pleasing.

However, one aspect that is enjoyed by many is the role of playing a bartender's role in that many people, like to mix the ingredients together to make the mixed drink itself instead of buying a drink that has been pre-mixed already. As will be appreciated, many of the ingredients that go into making a mixed drink have different colors and therefore, the mixing of these ingredients forms a drink that has yet another color. Existing pre-mixed drinks that are on the market do not allow the consumer the ability to mix the drink and at best, only permit the consumer to shake the already mixed drink. Also, some consumers believe that pre-mixing the non-alcoholic ingredients, such as juices, with the alcoholic ingredient may reduce the freshness of the drink if the mixed ingredients sit on a shelf for an extended period of time.

It would therefore be desirable to provide a container that can be initially filled with the ingredients of a mixed drink such that at least two of the ingredients are separated from one another until the consumer wishes for the mixing to occur. The present invention addresses this and other needs in the art.

### SUMMARY

A method of distributing and mixing a drink includes the steps of: providing a first container body and filling the first container body with a first fluid such that the first fluid is sealingly held within the first container body. The first container body has a first feature that permits the first fluid to selectively flow from the first container body. The method also includes the step of providing a second container body for holding a second fluid. The second container body has a second feature that permits the second fluid to flow from the second container body. The second container body is filled with the second fluid.

The first and second container bodies are joined such that the first and second fluids are separated from one another and are sealingly contained within the first and second container bodies, respectively. In addition, at least one of the first and second container bodies is manipulated at a point of use to provide fluid communication therebetween resulting in mixing of the first and second fluids.

A container for preparing a mixed drink including a first container body for holding a first fluid in a first compartment thereof. The first fluid is sealed at one end by a first membrane. The container includes a second container body for holding a second fluid in a second compartment thereof. The second fluid is sealed at one end by the first membrane. The container includes an object disposed within one of the first and second compartments. The object has sufficient dimensions and mass such that when mixing of the first and second fluids is desired, the container is manipulated to cause the object to strike and rupture the first membrane resulting in mixing of the first and second fluids.

### BRIEF DESCRIPTION OF THE DRAWING FIGURES

FIG. 1 is an exploded perspective view of container according to another embodiment for separately holding ingredients of a mixed beverage prior to mixing

FIG. 2 is an exploded cross-sectional view of the container of FIG. 1 taken along the line 2-2;

FIG. 3A is side cross-sectional view of a first body of the container in a first position relative to a second body of the container;

FIG. 3B is a side cross-sectional view of the first body being axially advanced relative to the second body to a second position;

FIG. 3C is a side cross-sectional view of the first body being further axially advanced relative to the second body to a third position;

FIG. 4A is a localized top plan view of a retaining feature in a first position;

FIG. 4B is a localized top plan view of the retaining feature in a second position;

FIG. 4C is a localized top plan view of the retaining feature in a third position;

FIG. 5A is side elevation view of a container according to another embodiment;

FIG. 5B is side elevation view of a container according to another embodiment;

FIG. 6 is a partial cross-sectional view of a container according to yet another embodiment;

FIG. 7 is a side perspective view of a container of another embodiment;

FIG. 8A is a cross-sectional view taken along the line 8-8 of FIG. 7;

FIG. 8B is a cross-sectional view similar to FIG. 8A with a pull tab in a rest position;

FIG. 8C is a cross-sectional view of the container with the pull tab being pulled causing separation of a membrane to provide communication between two container compartments; and

FIG. 9 is a bottom view of a first container body of the container.

### DETAILED DESCRIPTION OF PREFERRED EMBODIMENTS

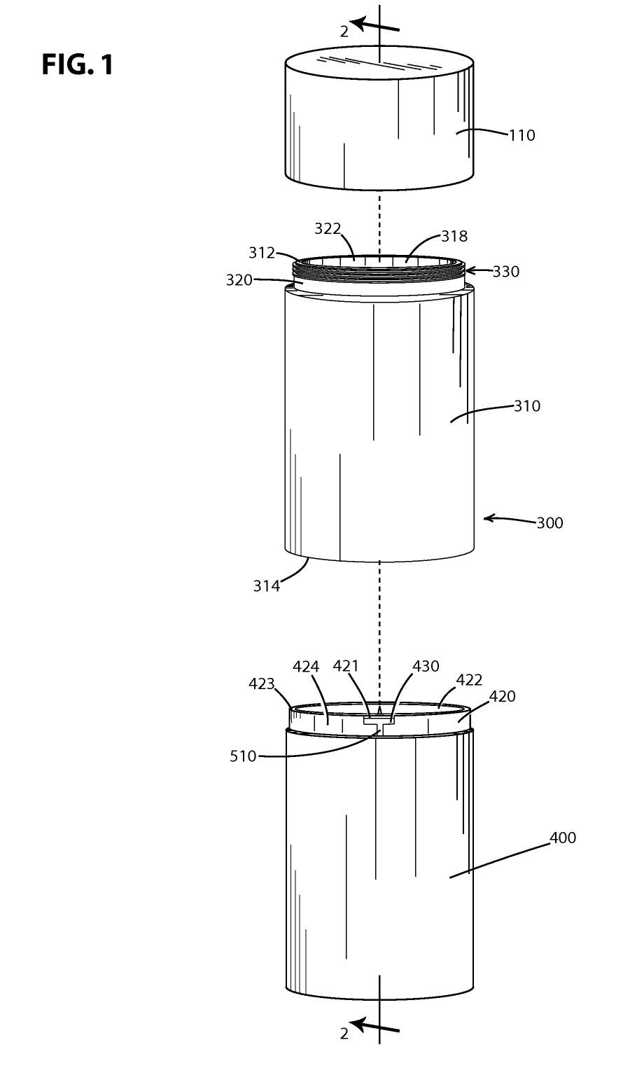

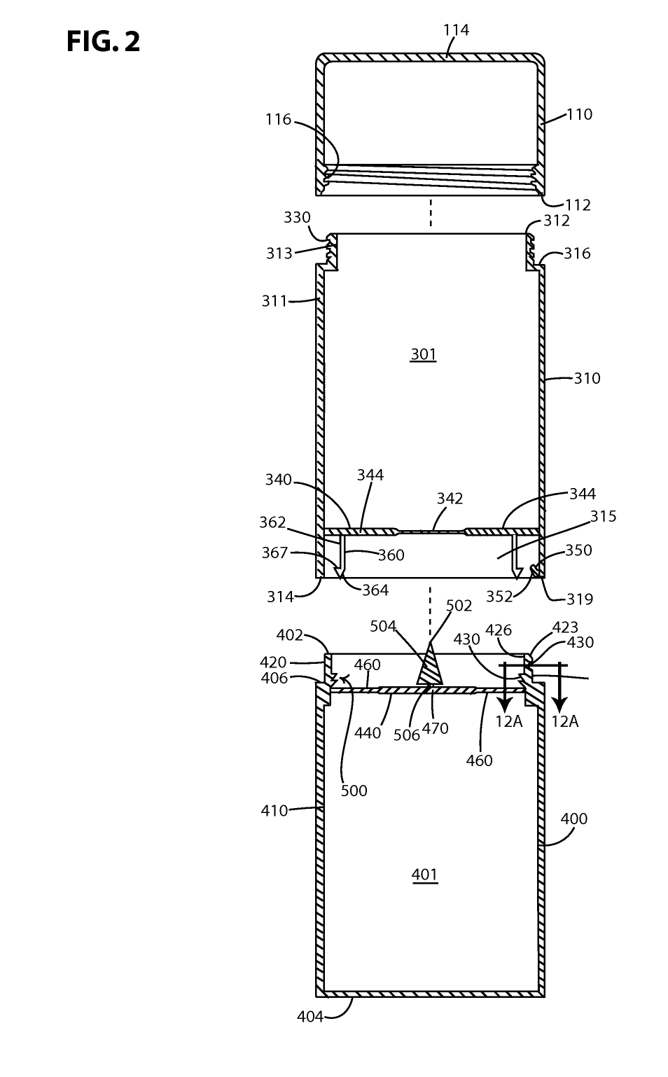

FIG. 1 is a side perspective view of a beverage container 300 according to one embodiment. The container 300 generally includes a lid or cover or cap 110, a first body 310 that defines a first compartment 301 for holding a first ingredient (e.g., a liquid) of the beverage and a second body 400 that is coupled to the first body and defines a second compartment 401 for holding a second ingredient (e.g., a liquid) of the beverage. As used herein, the term “ingredient” is not limited to a homogenous liquid; but instead can be formed of a number of mixed liquids. For example, one “ingredient” of the drink intended to be mixed within the container 300 can be a combination of several liquids, such as a combination of fruit juices, e.g., a combination of pineapple and orange juice that is intended to be later mixed with vodka. For purpose of illustration only, the first compartment holds a first liquid and the second compartment holds a second liquid.

In order to maximize the visual effect of the container mixing mechanism, the two ingredients should be visually different from one another. For example, a transparent alcohol(s) or the like should be contained in one compartment, while the colorful fruit juices, soda, or the like should be contained in the other compartment. Alternatively, one compartment can store a colored alcohol base liquid and the other compartment can store a transparent alcohol based liquid or even a colored alcohol.

In a specific exemplary embodiment, the two ingredients are two liquid components of a mixed drink that are intended to be mixed with one another to form the final mixed drink. For example, the first compartment can hold a fruit juice, such as orange juice or another juice, like cranberry juice, and the second compartment can hold alcohol, such as vodka. The first and second ingredients (liquids) should be complementary to one another in that in the resulting mixed drink, the first and second liquids are mixed with one another.

After mixing occurs, the consumer removes the lid 110 and enjoys the freshly mixed drink.

The container 300 includes the lid 110 that is releasably mated (e.g., threadingly secured) to the first container body 310 which selectively is coupled to the second container body 400. In one embodiment and similar to the previous embodiment, the first container body 310 can be in the form of a substantially hollow member defined by a side wall and that can have any number of different shapes, including, a cylindrical shape, as shown in FIG. 1.

The first container body 310 contains the first compartment 301 for receiving and holding a first fluid (e.g., liquid) and the second container body 400 includes the second compartment 401 for receiving and holding a second fluid (e.g., liquid).

The lid 110 is intended to selectively seal the first compartment and more specifically, the lid serves as cap or closure for sealingly closing off the entire container 100 when the lid is securely attached to the first body. Conversely, when the lid is detached and removed from the first body, at least the first compartment is open and accessible and in one orientation, both the first and second compartments 301, 401 are open and accessible through the open lid 110.

The lid 110 includes an open end 112 and an opposite closed end 114. The open end 112 includes first fastening features 116 for securely and sealingly coupling the lid 110 to the first body 310. In one embodiment, the lid 110 is in the form of a hollow cap that has a cylindrical shape. However, the lid 110 can have any number of different shapes other than a cylindrical shape. For example, the lid 110 can have a square shape, oval shape, etc.

In one exemplary embodiment, the first fastening features 116 are in the form of external threads that are formed at or near the open end 112. However, it will be appreciated that the first fastening features are not limited to being external or internal threads but can be any number of other structures so long as the first fastening features 116 produce a releasable, sealed interface between the lid 110 and the first body 310.

The illustrated first container body 310 has an open first end 312 that mates with the lid 110 and an opposite second end 314 and includes an annular shoulder 316 formed near the first end 312. The annular shoulder 316 is formed between a main section 311 of the first body 310 and a section 313 that has a reduced diameter. The section 313 is defined by an annular shaped side wall 318 that has an outer surface 320 and an opposite inner surface 322. The means 330 for securely attaching the lid 110 to the first end 312 of the container body 310 are preferably formed as part of the section 313 and in particular, the means 330 can be in the form of fastening features (e.g., threads) that are formed on the outer surface 320. In the case of threads 330, when the lid 110 is securely and threadingly attached to the first container body 310, a bottom edge of the lid 110 is seated within the shoulder 316 (e.g., at or near a horizontal surface of the shoulder 316).

The opposite second end 314 is a closed end in that it contains a bottom wall 340 that extends across the container body 310. When the container body 310 has a cylindrical shape, the bottom wall 340 has a disk-like construction (circular shape). The bottom wall 340 is slightly offset from the second end 314 so that a space 315 is formed between an underside of the bottom wall 340 and a 319 bottom edge of the container body 310. Preferably, the bottom wall 340 is formed perpendicular to an inner surface of the side wall of the container body 310.

According to one embodiment, the bottom edge 319 has at least one locating tab 350 formed as a part thereof. The locating tab 350 is directed inward away from the inner surface of the side wall of the container body 310. In other words, the locating tab 350 extends inward into the interior of the container body 310. The locating tab 350 is formed so that it has some flexing action and in particular, if a force is applied upward in direction parallel to the side wall of the container body 310, the locating tab 350 will flex inward toward the inner surface of the container body 310. The tab 350 includes a cam surface 352 to assist in the tab 350 being received within a complementary feature that is formed as part of the second container body 400 as described below. The cam surface 352 can be formed as a lower edge of the locator tab 350. In one exemplary embodiment, the cam surface 352 is in the form of a beveled edge.

According to one aspect of the present invention, the bottom wall 340 at least contains one section that is pierceable or otherwise rupturable. In the illustrated embodiment, the bottom wall 340 includes a first section 342 that represents the pierceable, rupturable, etc. section. However, in normal use, the bottom wall 340 effectively seals the second end 314 so that the second end 314 has a liquid tight seal. The coupling between the lid 110 and the first end 312 also forms a liquid tight seal so that when the lid 110 is attached to the first end 314, the first container body 310 is a self-contained structure that can hold a predetermined amount of liquid in a sealed manner.

For example, the bottom wall 340, along with the rest of the container 300, can be formed of a plastic material and consequently, the first section 342 can be a section of reduced thickness so that it can more easily be pierced by a member as described below. Alternatively, the first section 342 can be formed of a separate material relative to the surrounding sections of the bottom wall 340. For example, the first section 342 can be in the form of a thin membrane (e.g., formed of a different plastic or rubber material) that is attached to the bottom wall 340 using conventional techniques so long as a liquid tight, robust seal is formed between the first section 342 and the bottom wall 340. While, in the illustrated embodiment, the first section 342 is illustrated as being in a central region of the bottom wall 340, the first section 342 can be located in another region of the bottom wall, such as closer to the peripheral edge of the bottom wall 340.

An area 344 that surrounds the first section 342 contains one or more puncturing members 360 for piercing a complementary structure that is part of the second container body 400 as described below. The puncturing member 360 extends outwardly from an underside (lower surface) of the bottom wall 340 and in particular, the area 344 thereof.

In the illustrated embodiment, the puncturing member 360 is in the form of an elongated puncturing member 360 that has a base (post) 362 that is integrally attached to the area 344. The post 362 is perpendicular to the bottom wall 340 and at a distal end of the post 362, the puncturing member 360 includes a distal tip or end 364 that is formed so that it has a sharp tip or edge. In the illustrated embodiment, the distal end 364 has a sharp triangular shaped tip that is formed to have an underside 367 that is perpendicular to the post 362. The underside 367 is formed so that it is open and faces outward toward the inner surface of the first container body 310.

According to one embodiment, there are two puncturing members 360 that are formed as part of and are integrally attached to the area 344. The two puncturing members 360 are located opposite one another, i.e., 180 degrees a part from one another, on different sides of the area 342. Consequently, the two puncturing members 360 are attached to the bottom wall portion that has a greater thickness in order to provide robust upright perpendicular structure that are capable of maintaining their upright structure, while the puncturing members 360 pierce complementary membranes.

The distal tip or end 364 of the puncturing member 360 can extend slightly beyond the second end 314 of the body 310 or it can be positioned in the plane of the second end 314 or even be slightly recessed relative to the plane of the second end 314.

It will be appreciated that not only does the puncturing member 360 serve as a piercing member that pierces a structure, but it also functions a pawl of a ratchet type system. While the puncturing member 360 is for the most part rigid due to the post 362, it also has a degree of flexibility in that if a lateral force is applied to the puncturing member 360, the puncturing member 360 has a degree of flex in the lateral direction. For example, if a force is applied to the puncturing member 360 in an inward direction in that the force is applied in a direction from the inner surface of the side wall of the first container body 310, the puncturing member 360 flexes inward toward the other puncturing member 360.

The second container body 400 is similar to the second container body 140 in that it is constructed to selectively mate with the first container body 310. In one embodiment and like the previous embodiment, the second container body 400 can in the form of a substantially hollow member defined by a side wall and that can have any number of different shapes, including, a cylindrical shape, as shown in FIG. 1.

The illustrated second container body 400 has a selectively open first end 402 that mates with the first container body 310 and more particularly, is constructed to mate with the tab 350 associated with the first container body 310. The second container body 400 also includes an opposite second end 404 and includes an annular shoulder 406 formed near the first end 402. The annular shoulder 406 is formed between a main section 410 of the second container body 400 and a section 420 that has a reduced diameter. The section 420 is defined by an annular shaped side wall 422 that has an outer surface 424 and an opposite inner surface 426.

The second container body 400 includes a first coupling means or feature 430 that is designed to selectively couple the first container body 310 with the second container body 400 in an initial position. The first coupling means 430 is constructed to securely and initially couple the second container body 400 to the second end 314 of the first container body 310. The first coupling means 430 is formed so that it is part of the section 420 and in particular, the first coupling means 430 is complementary to the tab 350 so that the first coupling means 430 receives and engages the tab 350.

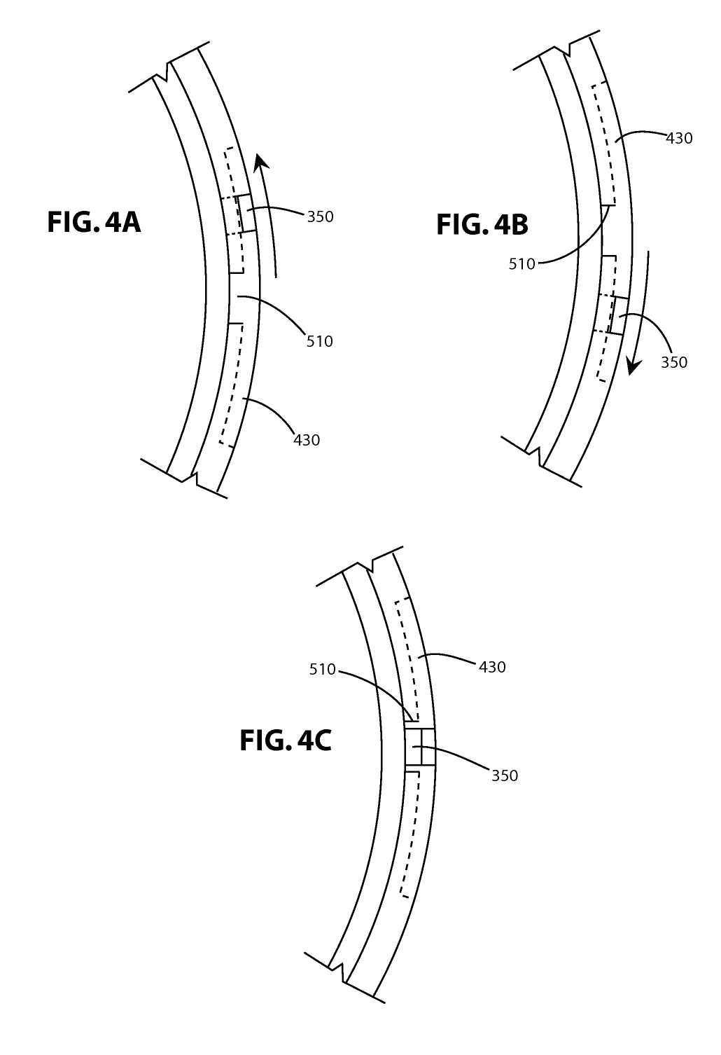

In particular, the first coupling means 430 is designed to engage, receive and selectively retain the tab 350 so as to fixedly locate and position the first container body 310 relative to the second container body 400. In one embodiment shown in FIGS. 1 and 4A-4C, the first coupling means 430 is in the form of a channel that is formed in the outer surface 424 of the section 420. The channel 430 does not have to be a completely circumferential channel in that it does not have to extend around the complete circumference of the outer surface 424 of the section 420 and thus be in the form of an endless channel. In other words, the channel 430 can extend only around a section of the second container body 400. For example, the channel 430 can extend less than 180 degrees, less than 90 degrees, less than 45 degrees around the circumference of the section 420.

An inner diameter of the side wall of the first container body 310 is equal to or slightly greater than an outer diameter of the section 420. This allows the lower section of the first container body 310 that is located below the bottom wall 340 to slidingly travel over the outer surface 424 of the section 420 for coupling the two container bodies 310, 400.

Channel 430 is a horizontal channel formed in the outer surface 424 of the section 420. The dimensions of the channel 430 are greater than the dimensions of the tab 350 but are complementary thereto so that when the tab 350 is received in the channel, the outward biasing force of the tab 350 causes the tab 350 to be retained and retained in the channel 430.

Preferably, a top edge 423 of the section 420 includes a cam surface 421 at least in the area of the channel 430 so as to assist in the reception of the tab 350 within the channel 430.

The channel 430 serves as a locating and retaining feature in that when the first container body 310 is mated with the second container body 400, the tab 350 slidingly travels over the cam surface 421 at the top edge 423 and rides into the channel 430 where the tab 350 is retained due to the comparative dimensions of the two structures.

In effect, the tab 350 is snap-lockingly retained within the channel 430. FIGS. 4A and 4B show this arrangement. Depending upon the construction of the channel 430 and in particular, if it is of an endless design or if the channel 430 contains two closed ends, the first container body 310 can be rotated a predetermined number of degrees relative to the second container body 400. In an endless channel design, the tab 350 can be rotated 360 degrees within the channel 430.

It will also be appreciated that the container 300 and in particular, the channel 430 thereof, can have a guide and lock feature to prevent inadvertent advancement of the first container body 310 toward the second container body 400. As described below in more detail, it is not advantageous to permit the first and second container bodies 310, 400 to freely move toward one another. As a result, the channel 430 can contain a guide and lock feature 500 that only permits axial advancement of the first container body 310 relative to the second container body 400 when the two parts are in a predetermined, select alignment.

FIG. 4A or 4B can be thought of as an initial first position of the container 300 in that the first container body 310 is initially coupled to the second body 400 by means of the tab 350 being received within the channel 430. The engagement of the tab 350 in the channel 430 causes the two parts to be securely coupled to one another such that the container 300 can be transported and distributed in this first position where the integrity of the first and second compartments 301, 401 of the container bodies 300, 400 is not jeopardized. At the same time, the joined container bodies 310, 400 can be freely picked up and moved, etc., without becoming separated from one another.

In one exemplary embodiment and as shown in FIG. 1, the guide and lock feature 500 can be in the form of a vertical guide channel 510 that has an open end that intersects and is open to the channel 430 and a closed end 512 that limits the vertical (axial) movement of the first container body 310 relative to the second container body 400. FIG. 1 shows an embodiment where the channel 430 is not of an endless design but instead, the channel 430 has two closed ends that limit the degree of rotation of the first and second container bodies 310, 400 since once the tab 350 comes into contact with one of the closed ends of the channel 430, the first container body 310 can not be further rotated in this direction.

A width of the vertical channel 510 should be greater than a width of the tab 350 so that when the tab 350 is within the vertical channel 510, there is some degree of rotation permitted between the first and second container bodies 310, 400. For example, the user can hold stationary the second container body 400 and twist or rotate the first container body 310. FIG. 4A shows this initial engagement.

The second container body 400 contains a second coupling means 500 that serves to selectively interlock with the puncturing members 360 to further interlock the first and second container bodies 310, 400 and to selectively puncture respective rupturable barriers so as to open up the first and second compartments 301, 401 to one another, thereby permitting the two liquids contained therein to mix with one another.

The mating of the puncturing members 360 (pawl) with the second coupling means 500 results in a fluid seal being formed between the first and second container bodies 310, 400. This fluid seal permits the fluid from the first compartment 301 to flow into the second compartment 401 and vice versa without any leakage in the section where the two container bodies 310, 400 are mated to one another.

The second coupling means 500 is in the form of a plurality of teeth 430 that are formed on the inner surface 422 of the section 420. The teeth 430 are inwardly directed and face inward toward the opposite ones. The teeth 430 can be formed circumferentially around the entire inner surface 422 of the section 420. However, it will be appreciated that the teeth 430 do not have to be formed circumferentially around the entire inner surface 422 of the section 420, but instead, the teeth 430 can be formed only in two distinct sections thereof that align with the two puncturing members 360.

The combination of the pawl members (puncturing members 360) and the teeth 430 provide a ratcheting system where the first container body 310 can be controllably driven and further advanced toward the second container body 400. In other words, once the first container body 310 is sufficiently advanced toward the second container body 400, the pawls engage first teeth which result in an audible noise, such as a clicking noise, and the user also receives tactile confirmation that the pawls have engaged the teeth. When the pawls and teeth mate, as in any ratcheting system, the two parts, in this case, the first and second container bodies 310, 400 are interlocked with one another but can be further advanced and moved relative to another by applying a sufficient force in the proper direction (here a direction that is parallel to the length of the first and second bodies) to the lid 110, which is thereby translated to the first and second container bodies 310, 400.

Similar to the first container body 310, the second container body 400 has a wall, in this case, an upper wall 440 that extends across and effectively seals the second container body 400 in a fluid tight manner since the opposite end of the second container body 400 is a closed end. When the second container body 400 has a cylindrical shape, the upper wall 440 is of a disk-like construction (circular shaped). The upper wall 440 is not located at the first open end of the second container body 400 but instead, it is slightly offset therefrom.

For example, the upper wall 440 can be formed as part of the section 420 or it can be formed near the juncture between the section 420 and the side wall of the container body 400. As with the first container body 310, the upper wall 440 has a section 460 that is more easily pierced than an adjacent section 470 to permit the second compartment 401 to be opened by piercing of the section 460. The section 460 can be a section of reduced thickness so as to allow it to be more easily pierced or it can be formed of a member that is different from the adjacent section 470. For example, the section 460 can be in the form of a thin membrane (plastic or rubber) that is sealingly attached to the adjacent section 470.

The section 460 has to be complementary to the area or section 342 of the first container body 310 in that the two sections 460, 342 do not overlie one another. Since the section 342 is located in a central region of the first container body 310, the section 460 is located radially outward from the section 342. For example, the section 460 can have an annular shape that is radially outward from and surrounds the section 470. In other words, the section 460 can be an outer annular band that lies outside of the section 470 (that has a circular shape) and is attached along it peripheral edge to the inner surface 422 of the section 420. The membrane or wall formed by the sections 460, 470 is formed so that it is below the teeth 430 in the that before the puncturing members 460 engage the section 460, the puncturing member 360 must engage the teeth 430 in a ratcheting manner.

The seal that is formed by the sections 460, 470 are liquid tight and therefore, the second container body 400 when sealed is a self-contained structure that can hold a liquid in a sealed manner.

The second container body 400 also contains a puncturing member 501 similar to the puncturing members 360 but it is constructed to pierce the area 344 of the first container body 310. The puncturing member 501 has a sharp tip 502 that is formed at a distal end of a body 504 that is integrally connected to the section 470. In the illustrated embodiment, the body 504 has a post 506 that is attached to the section 470 and the remaining section of the body 504 has a triangular shape with the tip 502 being formed at the distal tip and in facing relation with the first container body 310.

The puncturing member 501 is axially aligned with the area 342 so that as the first and second container bodies 310, 400 are moved toward one another as by ratcheting the first container body 310 toward the second container body 400, the puncturing member 501 engages and ultimately pierces the area 342 to open up the first compartment 301 of the first container body 300.

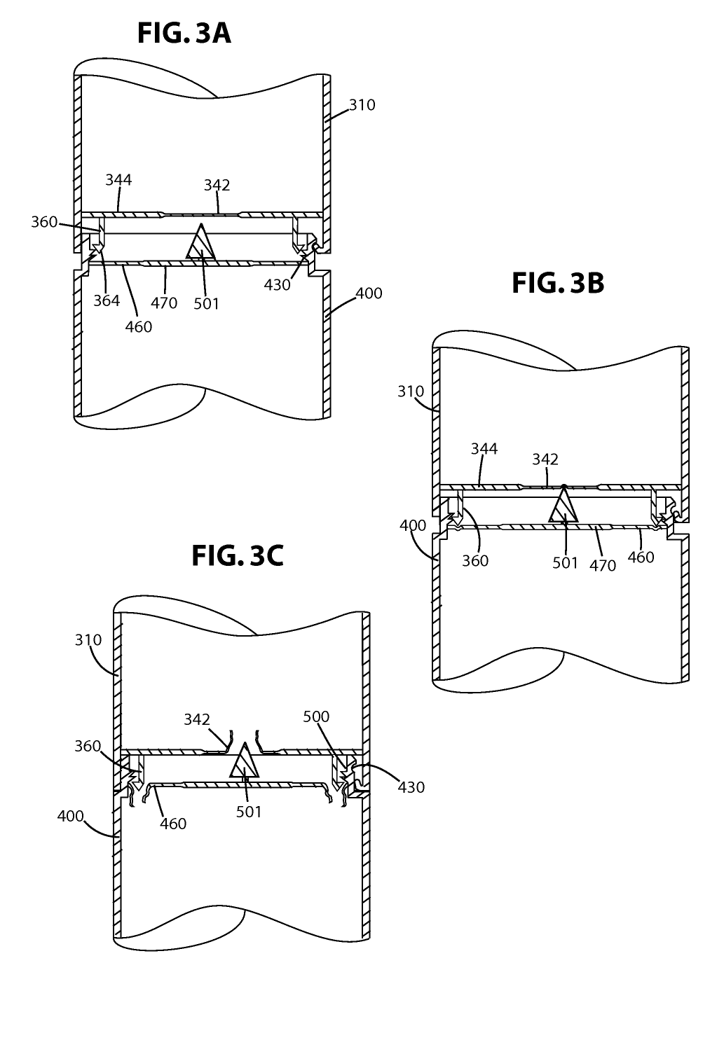

FIG. 3B shows this position where the pawls (puncturing members 360) are in initial engagement with the teeth 430. In this second position, it will be appreciated that the puncturing members 360 and puncturing member 500 have not yet pierced the section 460 and the area 342, respectively. The sharp tips of the puncturing members 360 and puncturing member 500 can be close to or in slight contact with the surfaces of the section 460 and area 342, respectively. As a result, the integrity of the first and second compartments 301, 401 has not been broken.

FIG. 3C shows the container 300 when the first container body 310 is further advanced by further ratcheting the first container body 310 toward the second container body 400 (or vice versa). In other words, a further force can be applied to the first container body 310 to cause the pawls (puncturing members 360) to further engage the teeth 430 and this further ratcheting between the pawls and teeth 430 results in the puncturing member 500 rupturing (puncturing) the area 342, due to the sharp tip 502 thereof piercing the membrane in the area 342, and the puncturing members 360 rupturing (puncturing) the section 460 due to the sharp tip 364 thereof piercing the membrane in the section 460. This rupturing action caused by the advancement of the puncturing members 360 and puncturing member 500 into and through the respective membranes or walls results in both the first and second compartments 301, 401 being opened up, thereby letting fluid (the first liquid) to flow out of the first compartment 301 and towards and into the second compartment 401 and vice versa, fluid from the second compartment 401 can flow out of the second compartment 401 and towards and into the first compartment 301. No leakage occurs during the opening of the compartments 301, 401 and during the flow of the liquids between the two compartments 301, 401 since the engagement between the puncturing members 360 and the section 420 is of a sealed nature, the two liquids flow directly between the two compartments 301, 401 without any leakage at the interface between the first and second container bodies 310, 400.

It will be appreciated that the container 100 and the ratcheting mechanism thereof permits the container 300 to be manipulated in a controlled manner such that the two liquids contained in the two compartments 301, 401 mix with one another. In this manner, a mixed drink can be made by simply pressing the first and second bodies 310, 400 toward one another until the two membranes are broken.

As with the first container 100, the container 300 can offer a visually pleasing mixing operation or even when the two liquids in the two compartments 301, 401 have different colors or are otherwise visually distinguishable from one another. For example, one compartment 301, 401 can contain a clear, colorless alcohol, such as vodka, and the other compartment 301, 401 can contain a colorful liquid, such as orange juice, pineapple juice, soda, etc., such that when the two membranes are ruptures and the two liquids migrate toward the opposite compartment, a colorful mixing occurs. In the example of a chambourd flavored liquid that has a purple color mixing with clear vodka, the container 100 initially is viewed to have a bright purple portion represented by one of the bodies and a clear, colorless portion represented by the other of the bodies and when the two mix together, the consumer can watch a purple wave of color flow into the other compartment and as the liquids mix, the purple hue becomes more and more diluted as it assumes a little purple hue.

After mixing is completed, the consumer can open the container 300 by removing the lid 110 and then the mixed drink can be drunk.

It will be appreciated the number of different drink combinations is endless in that there are a great number of mixed drinks suitable for the containers of the present invention. As a result, a great number of colorful, visually pleasing drinks can be created using a container of the present invention. In at least some of the embodiments of the present invention, the rate of mixing between the two compartments can be controlled.

For example, the degree of registration between the openings of the container 100 can be controlled which directly influences and controls the rate of mixing between the two liquids. A minimal amount of registration between the openings results in a slower rate of fluid flow and mixing between the two fluids as opposed to when the openings are completely aligned and the registration between the openings is maximized resulting in a greater rate of fluid flow and mixing between the two fluids. In the embodiment of the container 300, additional ratcheting can increase the degree of puncture and therefore, can influence the flow rate of the liquids.

By having the two liquids (fluids) sealed in separate structures (container bodies), the structures can be mixed and matched with one another. For example, a fruit based liquid can be matched with either a vodka based liquid or a rum based liquid depending upon the individual choice of the consumer. Additionally, the decision of which two container bodies are to be mated can be decided at the point of use as opposed to earlier at the point of purchase.

This capability to mix and match container bodies 310, 400 is particularly useful for distributing a number of containers as part of a “party pack” that includes container bodies that contain different liquids. For example, the party pack can contain a number of container bodies that hold clear, colorless alcoholic beverages, as well as a number of other container bodies that contain colorful liquids, or vice versa. The consumer would then be able to select two complementary structures to match and mate together.

As with the other embodiments, the container 300 can contain a barrier, such as a shrink wrap strip or it can contain a heat seal (localized) between the first and second container bodies 310, 400 to prevent the initial engagement of the pawls with the teeth 430 until the container is at a point of use and at which time, the consumer can remove or breaker the barrier, thereby permitting the two bodies 310, 400 to ratchet with respect to one another.

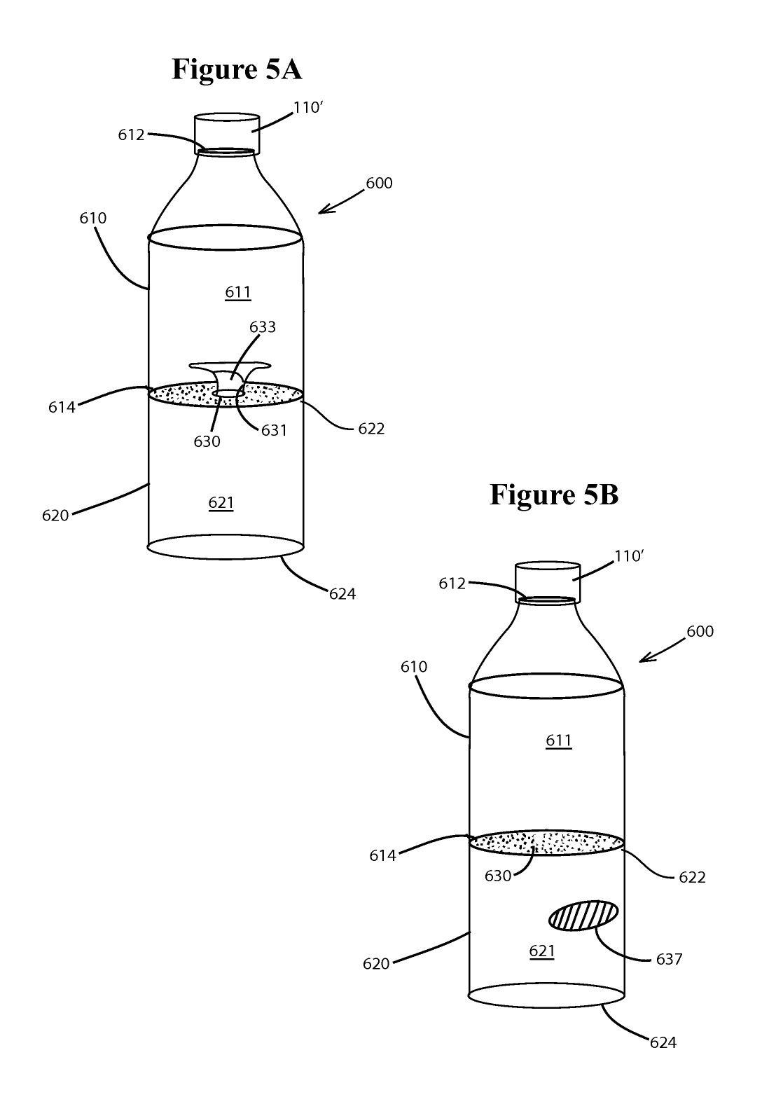

FIG. 5A illustrates another embodiment of the present invention in which a container 600 is illustrated and shares some similarities to the containers 100 and 300. In particular and like the containers 100 and 300, the container 600 is designed to hold two liquids in separate components prior to the user manipulating the bottle to cause the two liquids to mix together to form a mixed liquid, such as a mixed drink.

Container 600 includes a lid or cap 110′ which is releasably coupled to a first container body 610. The container body 610 includes a first end 612 which is designed to mate with and be securely and sealingly mated with the lid 110′. The consumer thus consumes the drink through the first end 612. Unlike the other embodiments, an opposite second end 614 of the first container body 610 is completely open and is defined by the side wall of the container body 610.

The container 600 also includes a second container body 620 that includes a completely open first end 622 and an opposite closed end 624. The open first end 622 is defined by the side wall of the second container body 620. The second container body 620 should have the same or approximately the same dimensions (e.g., diameter) as the first container body 610 to cause the side wall of the assembled container 600 to have relatively smooth finish from top to bottom.

The first and second container bodies 610, 620 are typically formed of a synthetic material, such as a plastic. In one example, the first and second container bodies 610, 620, as well as the lid 110′, are formed of a high density polyethylene.

In order to seal the first container body 610 to the second container body 620, a membrane 630 is provided and is sealingly attached to both the first end 622 of the second container body 620 and the second end 614 of the first container body 610 such that the membrane 630 extends across the container 500 and partitions the container 600 into a first compartment 611 defined by the first container body 610 and a second compartment 621 of the second container body 620. The membrane 630 can be in the form of a thin film (e.g., 0.05 mm polyethylene film) that extends across the container 600. The thin film 630 is attached to both the first end 622 and the second end 614 so as to define the two compartments 611, 621 and to provide an at least partially sealed structure. When the first and second container bodies 610, 620 have cylindrical shapes, the thin film 630 has a disk-shaped construction in that it has a circular shape.

The thin film 630 is attached to the first and second container bodies 610, 620 using conventional means, including, the application of heat to the thin film to cause, controlled localized melting to thereby permit the thin film 630 to bond to the two container bodies 610, 620. This is commonly referred to as using a hot melt seal or a heat seal. When the thin film 630 extends across the first and second container bodies 610, 620, it is preferably disposed perpendicular to the side wall of the container 600 and is parallel to the closed end 624 of the second container body 620. Other techniques can be used to join the first and second container bodies 610, 620 to one another.

The thin film 630 can, according to one embodiment, have an opening 631 formed therethrough. The opening 631 is can be formed anywhere along the surface of the thin film 630 and the size of the opening can be changed and is selected in view of several parameters, including the size of the container 600 (i.e., the container bodies 610, 620). A plug or object 633 is provided and is designed to plug or occlude the opening when the plug is in a first position prior to the consumer manipulating the container 600 at the point of use. The plug 633 thus blocks the opening until the consumer sufficiently manipulates (e.g., several vigorous shakes) the container 600 to cause the plug to become dislodged from the opening, thereby opening up a passageway between the first and second compartments 611, 621, resulting in mixing of the two different liquids.

It will be appreciated that the plug 633 has a shape and size so that it cannot travel through a neck of the first container body 610 and thereby, is not inadvertently swallowed. In the illustrated embodiment, the plug 633 has a portion that plugs the opening and a body that has a U-shape or C-shape, with the “wings” of the plug being separated and spaced apart from one another a greater distance than a diameter of the neck and therefore, the plug cannot fit through the neck of the first container body 610 even if the thin film 630 is completely broken during the manipulation.

It will also be appreciated that the plug 633 can be pre-fitted to the opening of the thin film 630 prior to sealing the thin film 630 to both container bodies 610, 620. The thin film 630 is then sealed to the first and second container bodies 610, 620 and then at a point of use, the consumer shakes the container 600 to cause dislodgement of the plug.

The plug 633 can be formed of a number of different materials, including plastic materials. While, the plug can include wings or the like to prevent it from traveling within and through the neck of the container body 610, it is also possible for the first container body 610 to also include a barrier, restrictor or the like that is below the neck of the first container body 610 for restricting the degree and ease of travel of the plug due to the dimensions of the barrier, plug and opening formed through the neck. For example, the barrier can be in the form of a ring structure that is attached to the container body 610 below the neck portion thereof. The barrier provides a structure that does not prevent fluid from flowing into and through the neck of the first container body 610; however, the barrier does serve to prevent any portion of the plug from entering the neck of the container body 610. This is particularly true if the plug has sharpened edges for piercing the thin film and in which case, it is desired to space the sharpened edges from the neck opening. The barrier (e.g., ring) thus restricts the movement of the plug relative to the neck opening to cause the plug to be spaced from the neck.

The force that is required to dislodge the plug is more than a force that would be experienced during normal shipment and stocking of packages containing the containers 600.

In another aspect as shown in FIG. 5B, the opening in the thin film 630 is eliminated and the plug is more in the form of an object 637 that is capable of piercing the thin film 630 to cause a rupture therein which results in the mixing of the two liquids. Once again, the piercing object 637 is of a size that prevents it from traveling through the neck of the first container body 610. In this embodiment shown in FIG. 5B, the object 637 can be thought of as a “rock” like structure that has sufficient density and mass to pierce the membrane 630 when the container is shaken causing contact between the object 637 and the membrane 630. When mixing is desired, the user simply shacks the container to cause the object 637 to strike the membrane 630 with sufficient force that a hole is punctured therein resulting in communication between and mixing of the first and second fluids. The object 637 is dimensioned relative to the dimensions of the opening of the container through which the user drinks so that the object 637 is prevented from flowing through the opening into the user's mouth since it has a dimension greater than the dimensions of the opening.

In yet another embodiment, the plug is eliminated and the thin film 630 is attached to the inner wall of the second container body such that one section of the peripheral edge of the thin film 630 is weakened relative to the surrounding peripheral edge sections and therefore, while it creates a fluid seal, it is more prone to breaking away from the inner wall when a force is applied thereto. The means for bonding the peripheral edge 630 can be selected so that in one particular section, the thin film 630 will separate from the inner wall under a force that can be generated by vigorously shaking the container 600. In particular, the second compartment is not completely filled to the top with the second liquid and therefore, the vigorous shaking of the container causes the second liquid to generate and apply a force against the thin film 630 and cause separation of the thin film 630 from the inner wall within this weakened section.

Alternatively, the thin film 630 can contain a perforated slit or circle or the like that is formed in the thin film 630 and is initially closed. This perforated area is a weakened area in the thin film 630 and therefore, when a sufficient force is applied to the perforated area, the thin film breaks along the perforations so as to create a passageway or opening that permits fluid in the first and second compartments 611, 621 to flow to the opposite compartment and mix with one another. Once again, the sufficient force that is applied to the thin film 630 can be generated by the vigorous shaking of the container which results in the liquid in the second compartment contacting the thin film 630 with a force that causes the perforated section to tear, thereby opening a passageway through the thin film 630.

In the embodiments where the container includes a thin film 630, the second liquid is added to the second container body 620, then the membrane (thin film 630) is secured to the container wall, before then adding the first liquid to the container such that the membrane supports the first liquid. For example, when the container is defined by the two container bodies, the thin film 630 can be bonded to the lower container body (after the second liquid has been added) using conventional techniques, including heat bonding, etc., and then the first container body can be disposed over the thin film 630 which is then bonded to the first container body by using conventional means, including heat bonding. Any excess material of the thin film 630 can be trimmed off to provide a clean look.

In one embodiment, the container 600 is a 125 ml (4 oz.) container formed of high density polyethylene (HDPE) and the membrane 630 is a thin film of polyethylene having a thickness of about 0.05 mm. It will be appreciated that the container 600 can be formed of other materials, such as PET or PETE or even a biodegradable material, such as PLA.

The size of the separate compartments of the various containers of the present invention can be selected in view of the particular product needs and therefore is not limiting. For example, each compartment can hold between 90 ml and 100 ml according to one embodiment.

It will further be understood that while the present invention has been discussed in terms of liquids being contained in the two compartments, other fluids and materials can be contained in the two compartments so long as the fluids and material have sufficient viscosity to permit the fluids/materials to flow from one compartment to the other compartment. For example, the compartments can contain two different solids (e.g., powders or gel-like substances) which are mixed with one another by manipulating the container resulting in a mixture being formed. This type of arrangement is particularly suited for cosmetic products or spa products where two substances that can be liquids or solids, gels, or a combination thereof, can be initially stored in separate sealed compartments and then mixed together by selectively opening up communication between the two compartments.

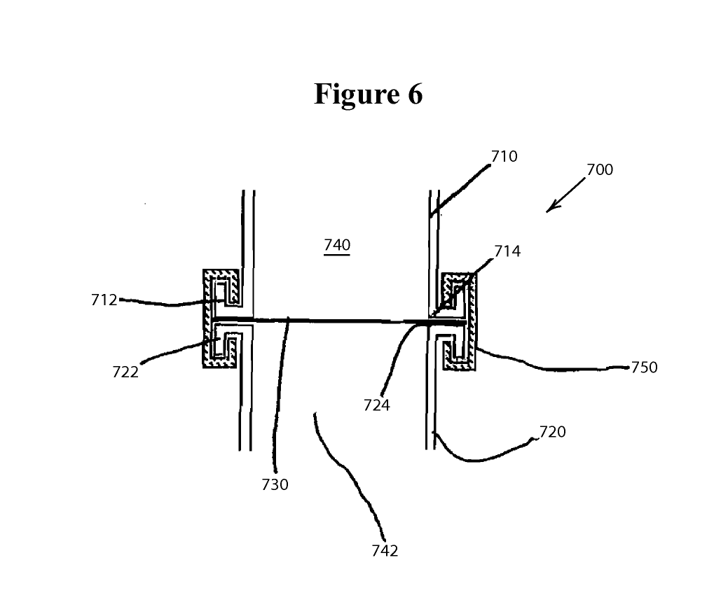

FIG. 6 is a cross-sectional view of a container 700 according to another embodiment. Similar to the other embodiments, the container 700 includes a first container body 710 and a second container body 720. The first container body 710 has a flange 712 at one end 714 thereof and similarly, the second container body 720 has a flange 722 at one end 724 thereof. The two flanges 712, 722 mate together and in particular seat against one another.

A membrane 730, such as a synthetic film or membrane (e.g., polyethylene film) that extends across the interior of the container 700 so as to partition and define a first compartment 740 in the first container body 710 and a second compartment 742 in the second container body 720.

An expansion ring 750 is provided and fits around and mates with the first and second flanges 712, 722. For example, the expansion ring 750 can be oval shaped and formed of a synthetic material, such as a plastic material. The expansion ring 750 is constructed and designed so that the turning of the expansion ring 750 causes the container 700 to expand which is translated into the integrity of the membrane 730 being impacted and in particular, the membrane 730 is at least partially dislodged or deformed so that a passageway is created between the two compartments 740, 742 to permit mixing of fluids contained in the two compartments 740, 742.

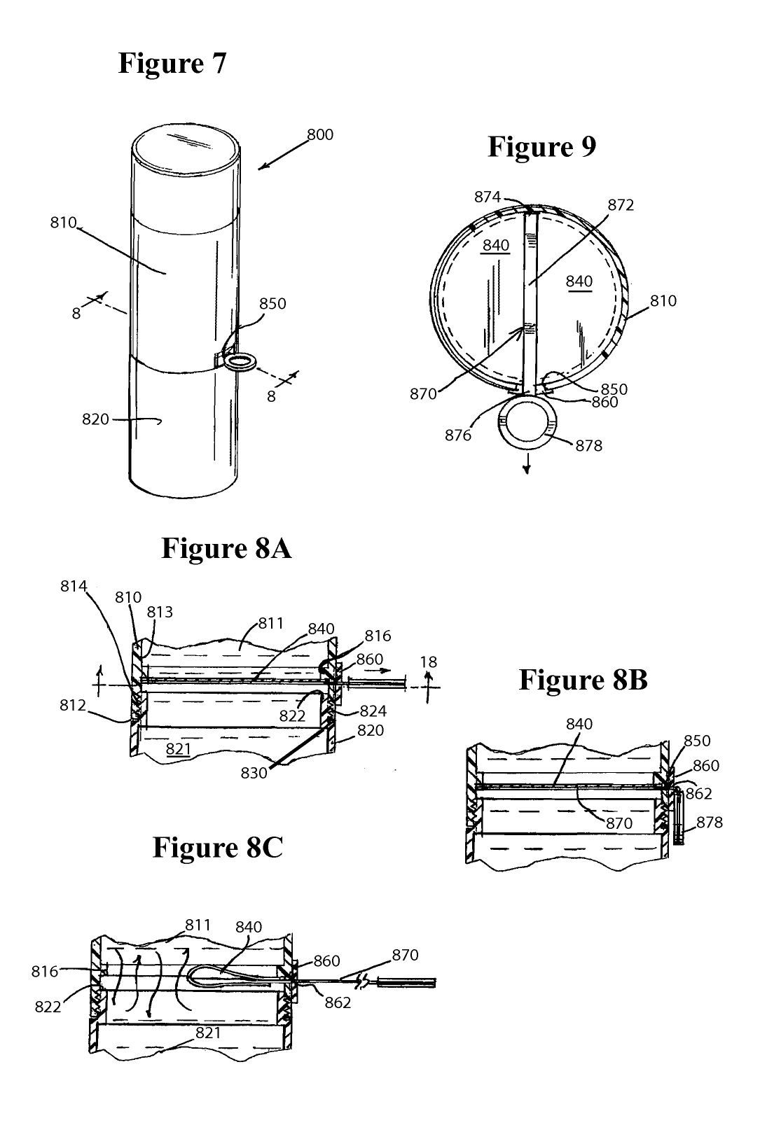

Now referring to FIGS. 7-9 in which a container 800 according to another embodiment is illustrated. The container 800 is similar to the other previous embodiments and therefore, not all of the components of the container 800 are described in detail since they have been previously described with reference to other containers. The container 800 includes a first container body 810 that defines a first compartment 811 and a second container body 820 that defines a second compartment 821. The container body 810 includes a first open end 812 that has a first coupling feature 814, such as threads formed on an inner surface of the sidewall of the first container body 810. The inner surface of the sidewall of the container body 810 also includes an annular tab or ring 816.

The second container body 820 has an open end 822 that includes an outer surface that has a second coupling feature 824, such as threads formed on an outer surface of the sidewall of the second container body 820. The first and second coupling features 814, 824 complement one another and result in the two container bodies 810, 820 being attached to one another. In the illustrated embodiment, the end of the 822 of the second container body 820 has a section of reduced diameter such that a shoulder 830 is formed between the reduced diameter section and the other sidewall portion. The second coupling feature 824 is formed in the outer surface of this reduced diameter section and when the first container body 810 is mated with the second container body 820, the end 812 seats against the shoulder 830.

A membrane 840 is attached to an inner surface 813 of the sidewall of the first container body 810 and in particular, the membrane 840 is attached to the inner surface 813 adjacent and below the annular ring 816. The membrane 840 is also preferably attached to an underside of the annular ring 816 along its peripheral edge. The shape of the membrane 840 is selected in view of the shape of the container body 810 so that membrane 840 extends completely across the interior of the body 810 so as to seal the first compartment 811. In the illustrated embodiment, the membrane 840 has a circular shape and is formed of a thin material, such as a plastic thin layer or film.

The membrane 840 is sealed to the first container body 810 along its peripheral edge as shown in FIG. 9.

In accordance with one aspect of this embodiment, the sidewall of the first container body 810 includes a side opening or slot 850 that provides an entrance into the first compartment 811. The side opening 850 has a grommet 860 associated therewith that serves to seal the side opening 850. The grommet or the like 860 is formed of a flexible, resilient material, such as a rubber material, that includes a slot 862 that is self-closing due to memory properties of the grommet 860.

The container 800 also includes a pull tab 870 that includes an elongated body 872 that has a distal end 874 and a proximal end 876. At the proximal end 876, a handle or finger ring 878 is provided to permit a user to grip and pull the pull tab 870. The pull tab 870 is arranged so that it extends through the slot 862 of the grommet 860 so that the second compartment 821 is sealed to the exterior even in the grommet area.

The opening 850 and slot 862 are formed below the annular ring 816 and also below the membrane 840 so that the pull tab 870 is disposed below the membrane 840. The distal end 874 of the pull tab body 872 is attached to a point (region) of the membrane 840 (e.g., a point across the grommet 860 and slot 862). In other words, the distal end 874 is attached to an underside of the membrane 840. The remaining portion of the body 872 is not attached to the membrane 840 or other component. FIGS. 17A-C also show the arrangement between the membrane 840 and the pull tab 870 and the pull tab 870 extending through the slot 862.

As shown in FIG. 8c, when the user wishes to mix the contents of the first and second compartments 811, 821, the user simply pulls the pull tab 870 by gripping and pulling the finger ring 878 and then pulling the tab 870 outwardly from the container 800. Since the membrane 840 is attached along its complete perimeter and since the pull tab 870 is attached to the membrane 840 at the distal end 874, the pulling action of the tab 870 causes the membrane 840 to detach at the point where the tab 870 is attached to the membrane 840. As the pull tab 870 is pulled and the membrane 840 becomes detached from the inner surface of the first container body 810, the continued pulling causes the membrane 840 to roll under itself, thereby creating a greater passageway or opening between the two compartments 811, 821. This results in the mixing of the fluids contained in the first and second compartments 811, 821.

It will be appreciated by persons skilled in the art that the present invention is not limited to the embodiments described thus far with reference to the accompanying drawings; rather the present invention is limited only by the following claims.

What is claimed is:

1. A method of distributing and mixing a drink comprising the steps of:
providing a first container body;
filling the first container body with a first fluid such that the first fluid is sealingly held within the first container body, the first container body having a first feature that permits the first fluid to selectively flow from the first container body;
providing a second container body for holding a second fluid; the second container body having a second feature that permits the second fluid to flow from the second container body;
filling the second container body with the second fluid;
joining the first and second container bodies such that the first and second fluids are separated from one another and are sealingly contained within the first and second container bodies, respectively; and
manipulating at least one of the first and second container bodies at a point of use to provide fluid communication therebetween resulting in mixing of the first and second fluids.

2. The method of claim 1, wherein an open end of the first container body is completely closed by a first membrane and an open end of the second container body is completely closed by a second membrane, and the step of manipulating at least one of the first and second container bodies comprises the step of:
advancing at least of the first and second container bodies toward the other until the first and second membranes are at least partially punctured resulting in the first and second fluids mixing with one another.

3. The method of claim 2, wherein the first container body includes a first ratcheting feature and the second container body includes a second ratcheting feature that mates with the first ratcheting feature to provide a ratcheting action between the two container bodies to advance the container bodies toward one another.

4. The method of claim 3, wherein the first container body includes a first puncturing member for rupturing the second membrane and the second container body includes a second puncturing member for rupturing the first membrane.

5. The method of claim 4, wherein the each of the first and second puncturing members comprises a pointed structure.

6. The method of claim 2, wherein each of the first and second membranes is formed of a rupturable material.

7. The method of claim 3, wherein the first ratcheting feature comprises a pawl and the second ratcheting feature comprises a toothed structure that mates with the pawl to only permit advancement of the first container body in a first direction toward the second container body.

8. The method of claim 3, wherein the first container body has a lock feature defined by a locking tab formed as part of the first container body and the second container body has a channel that receives the locking tab, the channel having a horizontal section and a vertical section that intersects the horizontal component, wherein ratcheting and advancement of the first container body towards the second container body is only possible when the locking tab is aligned with and received in the vertical section.

9. The method of claim 1, wherein an open end of the first container body is completely closed by a first membrane, the first container body having a pull tab that extends through an opening formed in a side wall of the first container body and is attached to a portion of the first membrane, and the step of manipulating at least one of the first and second container bodies comprises the step of:
pulling the pull tab to cause a localized section of the first membrane to dislodge from being sealed to the first container body resulting in the first and second fluids mixing with one another.

10. The method of claim 9, wherein the first membrane is sealingly attached about its peripheral edge to the first container body and the first membrane dislodges first from the first container body in a region where the pull tab is attached to the first membrane.

11. The method of claim 9, wherein a gasket is received in the opening, the gasket including a slot through which the pull tab is received, the gasket being at least substantially in sealed contact with the pull tab.

12. The method of claim 1, wherein at least one of the first and second fluids contains alcohol and the first and second fluids are visually distinguishable from one another.

13. A method of distributing and mixing a drink comprising the steps of:
providing a first container body;
filling a first fluid within a first compartment of the first container body and sealing the first fluid in the first container body with a first membrane;
providing a second container body that has a second compartment;
joining the first and second container bodies such that the first and second compartments are sealed from one another;
filling a second fluid within the second container, the second fluid being sealed within the second container body by the first membrane such that the first and second fluids are separated from one another;
disposing an object in at least one of the first and second compartments; and
moving, at a point of use, the container to cause the object to contact and rupture the first membrane resulting in mixing of the first and second fluids.

14. The method of claim 13, wherein the first membrane is a thin plastic film and the object is a solid object that has a density greater than a density of both the first and second fluids.

15. The method of claim 14, wherein the object has dimensions greater than a dimension of a drinking opening formed as part of the second container body for drinking the mixed drink, thereby preventing the object from being discharged from the container.

16. A container for preparing a mixed drink comprising:
a first container body for holding a first fluid in a first compartment thereof, the first fluid being sealed at one end by a first membrane, the first container body having a first coupling feature proximate the first membrane; and
a second container body for holding a second fluid in a second compartment thereof, the second fluid being sealed at one end by a second membrane, the second container body having a second coupling feature proximate the second membrane and configured to mate with the first coupling feature for joining the first and second container bodies in a manner in which the two can be moved relative to one another;
wherein in an initial position, the first and second container bodies are joined together such that the first and second fluids are separated from one another and are sealingly contained within the first and second container bodies, respectively, and the first and second container being configured so that selective movement between the two container bodies to a mix position results in the first and second container bodies being placed in fluid communication with one another resulting in mixing of the first and second fluids.

17. The container of claim 16, wherein the first coupling feature is a first ratcheting feature that includes a sharp tip and the second coupling feature is a second ratcheting feature that mates with the first ratcheting feature to provide a ratcheting action between the two container bodies to advance the first and second container bodies toward one another, wherein in the mix position, the tip of the first ratcheting feature ruptures the second membrane and a puncturing member associated with the second container body ruptures the first membrane.

18. The container of claim 17, wherein the first ratcheting feature comprises a pawl and the second ratcheting feature comprises a toothed structure that mates with the pawl to only permit advancement of the first container body in one direction toward the second container body.

19. A container for preparing a mixed drink comprising:
a first container body for holding a first fluid in a first compartment thereof, the first fluid being sealed at one end by a first membrane, the first container body having a first coupling feature proximate the first membrane;
a second container body for holding a second fluid in a second compartment thereof, the second container body having a second coupling feature proximate the second membrane and configured to mate with the first coupling feature for joining the first and second container bodies; and
a pull tab that extends through an opening formed in a side wall of the first container body and is attached to a portion of the first membrane, the pull tab being configured so that when the pull tab is pulled, a localized section of the first membrane is dislodged from being sealed to the first container body resulting in the first and second fluids mixing with one another.

20. The container of claim 19, wherein the first membrane is sealingly attached about its peripheral edge to the first container body and the first membrane dislodges first from the first container body in a region where the pull tab is attached to the first membrane.

21. The container of claim 19, wherein a gasket is received in the opening in the side wall, the gasket including a slot through which the pull tab is received, the gasket being at least substantially in sealed contact with the pull tab.

22. A container for preparing a mixed drink comprising:
a first container body for holding a first fluid in a first compartment thereof, the first fluid being sealed at one end by a first membrane;
a second container body for holding a second fluid in a second compartment thereof, the second fluid being sealed at one end by the first membrane; and
an object disposed within one of the first and second compartments, the object having sufficient dimensions and mass such that when mixing of the first and second fluids is desired, the container is manipulated to cause the object to strike and rupture the first membrane resulting in mixing of the first and second fluids.

23. The container of claim 22, wherein the object comprises a solid object that has a density that is greater than a density of both the first and second fluids.
